(19) United States
(12) Patent Application Publication
(10) Pub. No.: US 2015/0357759 A1
(43) Pub. Date: Dec. 10, 2015

(54) POWER LINE PLUG

(71) Applicant: Meng-Chang LIU, Nantou County (TW)

(72) Inventor: Meng-Chang LIU, Nantou County (TW)

(21) Appl. No.: 14/301,091

(22) Filed: Jun. 10, 2014

(51) Int. Cl. H01R 13/633; H01R 24/28

(52) U.S. Cl. CPC H01R 13/6335; H01R 24/28; H01R 2103/00

(57) ABSTRACT

A power line includes: a fixing base, a pull lug and a power line, where the fixing base has a connection portion, an abutting surface abutting the socket and an outer side with the back facing the abutting surface, the abutting surface is provided with a plurality of plug pins, and one of the plug pins is inserted into a plug hole of the socket; and the pull lug surrounds the periphery of the fixing base, an interval exists between the pull lug and the fixing base, the pull lug has a first end and a second end which are connected to the connection portion, and the first end and the second end have elastic deflection, so that the pull lug performs direction rotation by means of the first end and the second end, and one end of the power line is connected to the power line plug.

### BACKGROUND OF THE INVENTION

1. Field of Invention

The present invention relates to a power line plug, and particularly to a plug structure having a pull ring which provides convenience for a finger to hook, pull or separate from a socket.

2. Related Art

Accordingly, FIG. 1 and FIG. 2 show a first flat plug in the prior art, which includes a plug 1 and a semi-circular pull ring 2. The plug 1 is formed by fastening an upper cover 3 and a foundation 4, the upper cover 3 is provided with two vertically symmetrical upper grooves 5 adjacent to the periphery the upper cover 3, and the foundation 4 is also provided with two vertically symmetrical lower grooves 6 adjacent to the periphery of the foundation 4. After the upper cover 1 and the foundation 4 are fastened to form the plug 1, the upper groove 5 and the lower groove 6 are jointed so that two inner holes 7 are formed at left and right sides of the plug 1. Left and right sides of the pull ring 2 are each provided with a hooking lug 8 bending inward, the inner hole 7 is just provided for the hooking lug 8 to be inserted and hooked, and by pulling the pull ring 2, it is convenient to unplug the plug 1 from a plug hole of a socket (not shown). The pull ring 2 is hooked into the inner hole 7 by means of elasticity of the pull ring 2, so when a drawing force of a user for drawing the pull ring 2 is greater than a binding force of the pull ring 2 and the plug 1, the pull ring 2 is deformed to make the hooking lug 8 get out of the inner hole 7, so as to cause a danger of tumbling or tossing a palm out to collide with a hard object.

With respect to defects of the foregoing first flat plug, a person skilled in the art thereby researches and develops a second flat plug in the prior art shown FIG. 3 and FIG. 4, which includes: a plug casing 1a, where three conducting members 2a protrude from a side of the plug casing 1a, the plug casing 1a is connected to a power line 3a, the plug casing 1a is locked with a pull ring 4a, left and right sides of the pull ring 4a are each threaded by a pivot member 5a such as a screw, and the pivot member 5a is screwed with the plug casing la, so that the pull ring 4a is pivoted to the plug casing 1a and may rotate outward, which provides convenience for a finger to perform hooking, apply a force and perform pulling.

During use, the pull ring 4a may be pulled, and the plug 1 is unplugged from a plug hole of a socket (not shown), and is locked with the plug casing la by using the pull ring 4a, so as to solve the problem of the flat plug in the prior art in FIG. 1 and FIG. 2 that when the drawing force for drawing the pull ring 2 is greater than the binding force of the pull ring 2 and the plug 1, the pull ring 2 is deformed to make the hooking lug 8 get out of the inner hole 7, so as to cause a danger of tumbling or tossing a palm out to collide with a hard object.

However, the foregoing second flat plug in the prior art has a very complex structure and many components, the manufacturing cost is relatively increased and naturally reflected on the selling price, which is unacceptable to a majority of consumers, so the second flat plug is noncompetitive in the market.

### SUMMARY OF THE INVENTION

A main objective of the present invention lies in providing a structure which is firm, durable and simple, has a market competitiveness of a low selling price, and may solve the problem that in the flat plug in the prior art, when the drawing force for drawing the pull ring is greater than the binding force of the pull ring and the plug, the pull ring is deformed to make the hooking lug get out of the inner hole, so as to cause a danger of tumbling or tossing a palm out to collide with a hard object.

To achieve the foregoing objective, the present invention discloses a power line plug, plugged into a socket to connect to a power supply, where the power line plug includes: a fixing base, having a connection portion, an abutting surface abutting the socket and an outer side with the back facing the abutting surface, where the abutting surface is provided with a plurality of plug pins, and one of the plug pins is inserted into a plug hole of the socket; and a pull lug, surrounding the periphery of the fixing base, where an interval exists between the pull lug and the fixing base, the pull lug has a first end and a second end, the thickness of each of which is less than that of the pull lug and which are connected to the connection portion, and the first end and the second end have elastic deflection, so that the pull lug performs direction rotation by means of the first end and the second end.

The power line plug is connected to a power line, one end of the power line is connected to a periphery portion of the power line plug and is adjacent to the connection portion, and the pull lug and the power line are in different directions.

The power line plug is circular, the interval is disposed around the outline of the fixing base and passes through the diameter of the fixing base, two ends of the fixing base then extend toward the direction of the power line and terminate at the connection portion, and the distance between two ends of the interval is less than the diameter of the fixing base, so that the fixing base is formed with a mushroom head outline.

The pull lug is adjacent to the outer side, and the thickness of the pull lug is less than the thickness of the fixing base.

A diametric plane of the pull lug away from the plug pin and the outer side are different planes, and another diametric plane of the pull lug adjacent to the plug pin is lower than the abutting surface, so that the thickness of the pull lug is less than the thickness of the fixing base.

The first end and the second end of the pull lug are twisted so that the first end and the second end of the pull lug decrease in the thickness and are connected to the connection portion.

By means of the foregoing structure, a thumb of a user may push up the pull lug from bottom to top, the pull lug is obliquely arranged at the fixing base, which facilitates a finger to hook the pull lug, and a force is applied to pull out the power line plug upward, and the plug pin of the power line plug is separated from the plug hole of the socket, and therefore advantages of rapidness and labor saving are provided. Therefore, the present invention sufficiently solves the problem of the first flat plug in the prior art shown in FIG. 1 and FIG. 2 that, when a drawing force of a user for drawing a pull ring is greater than a binding force of the pull ring and the plug, the pull ring is deformed to make a hooking lug get out of an inner hole, so as to cause a danger of tumbling or tossing a palm out to collide with a hard object. Compared with the second flat plug in the prior art shown in FIG. 3 and FIG. 4, the plug of the present invention has advantages of a simpler structure, a greatly reduced manufacturing cost, and a relatively lower selling price, being acceptable to a majority of consumers and having a market competitiveness.

### BRIEF DESCRIPTION OF THE DRAWINGS

The present invention will become more fully understood from the detailed description given herein below for illustration only, and thus are not limitative of the present invention, and in which:

FIG. 1 is a three-dimensional exploded view of a first flat plug in the prior art;

FIG. 2 is a three-dimensional assembly view of the first flat plug in the prior art;

FIG. 3 is a three-dimensional exploded view of a second flat plug in the prior art;

FIG. 4 is a three-dimensional assembly view of the second flat plug in the prior art;

FIG. 5 is a three-dimensional schematic view of a socket in cooperation according to an embodiment of the present invention;

FIG. 6 is a three-dimensional view in another direction according to an embodiment of the present invention;

FIG. 7 is a top view according to an embodiment the present invention;

FIG. 8 is a front view according to an embodiment the present invention;

FIG. 9 is a first schematic view of an action on a socket in cooperation according to an embodiment of the present invention;

FIG. 10 is a second schematic view of an action on a socket in cooperation according to an embodiment of the present invention; and

FIG. 11 is a third schematic view of an action on a socket in cooperation according to an embodiment of the present invention.

### DETAILED DESCRIPTION OF THE INVENTION

Detailed content and technical description relevant to the present invention are further described with embodiments, but it should be understood that, the embodiments are only used as exemplary description, but should not be construed as a limitation to implementation of the present invention.

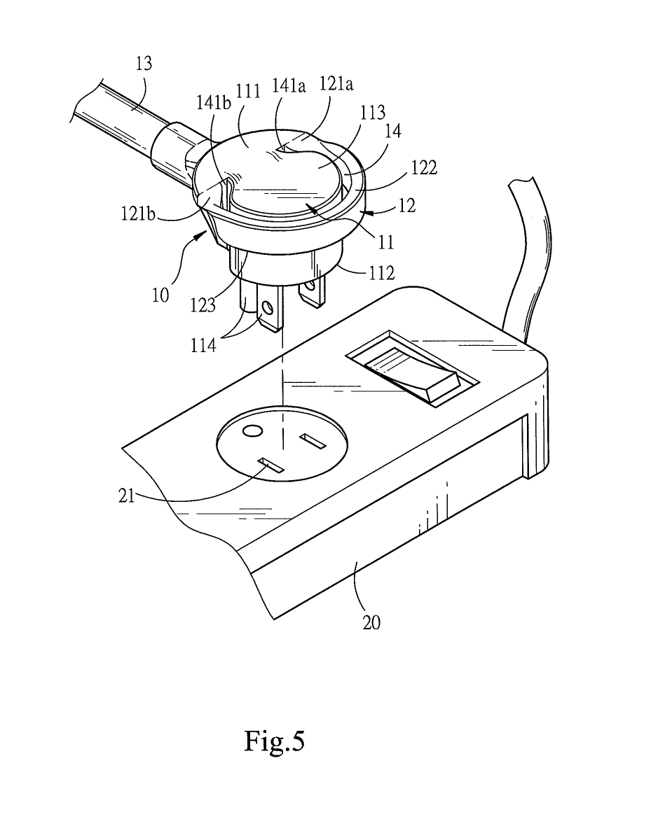

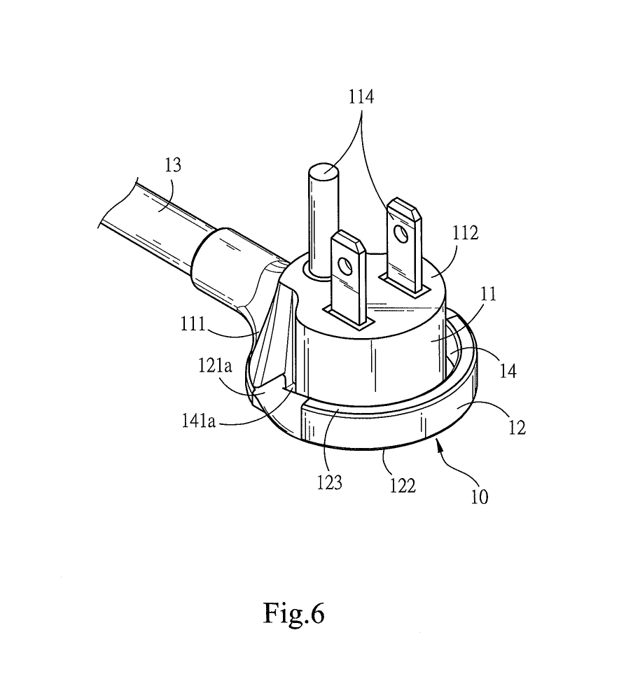

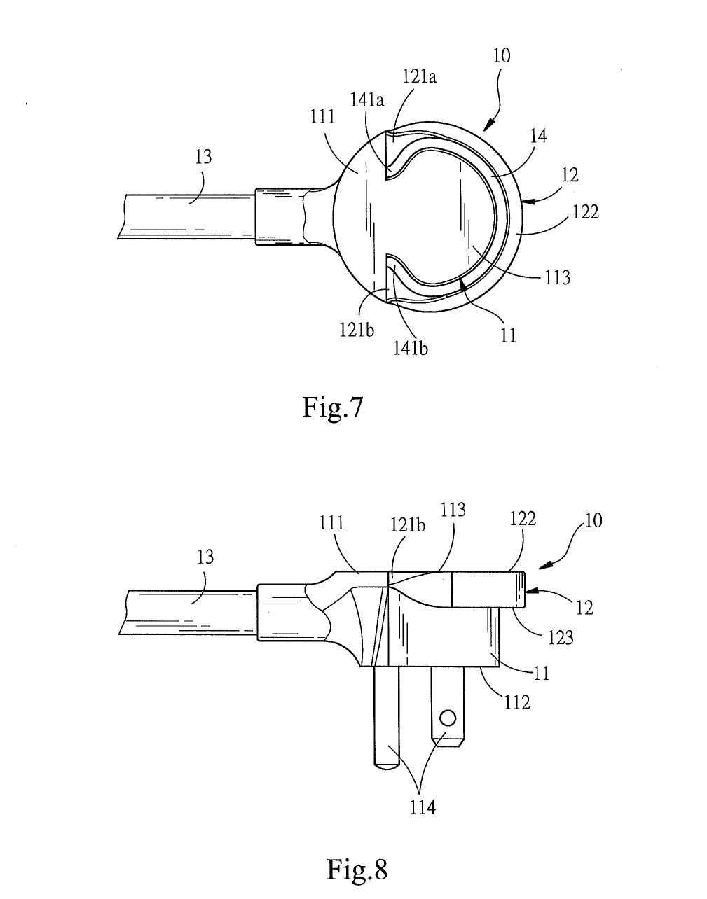

Referring to FIG. 5 to FIG. 8, FIG. 5 is a three-dimensional schematic view of a socket in cooperation according to an embodiment of the present invention; FIG. 6 is a three-dimensional view in another direction according to an embodiment of the present invention; FIG. 7 is a top view according to an embodiment the present invention; FIG. 8 is a front view according to an embodiment the present invention. The present invention discloses a power line plug, which is plugged into a socket 20 to connect to a power supply, and the power line plug 10 is circular, and includes: a fixing base 11, a pull lug 12 and a power line 13. The fixing base 11 is approximately semi-circular and has a connection portion 111, an abutting surface 112 abutting the socket 20 and an outer side 113 with the back facing the abutting surface 112, the abutting surface 112 is provided with a plurality of plug pins 114, and each of the plug pins 114 is inserted into a plug hole 21 of the socket 20.

The pull lug 12 surrounds the periphery of the fixing base 11, an interval 14 exists between the pull lug 12 and the fixing base 11, the interval 14 is disposed around the outline of the fixing base 11, passes through the diameter of the fixing base 11, and then extends toward the direction of the power line 13 so that two ends 141a and 141b of the interval 14 terminate at the connection portion 111. The distance between the two ends 141a and 141b of the interval 14 is less than the diameter of the fixing base 11, so that the fixing base 11 is formed with a mushroom head outline.

Also, the pull lug 12 has a first end 121a and a second end 121b which are connected to the connection portion 111, and the first end 121a and the second end 121b have elastic deflection, so that the pull lug 12 may be pulled up and perform direction rotation by means of the first end 121a and the second end 121b. The location of the pull lug 12 is adjacent to the outer side 111 of the fixing base 11, and the thickness of the pull lug 12 is less than the thickness of the fixing base 11. In this embodiment, a diametric plane 122 of the pull lug 12 away from the plug pin 114 and the outer side 113 are different planes, and another diametric plane 123 of the pull lug 12 adjacent to the plug pin 114 is lower than the abutting surface 112, so that the thickness of the pull lug 12 is less than the thickness of the fixing base 11. The first end 121a and the second end 121b of the pull lug 12 are twisted so that the first end 121a and the second end 121b decrease in the thickness and are connected to the connection portion 111.

One end of the power line 13 is connected to the power line plug 10. In this embodiment, one end of the power line 13 is connected to a periphery portion of the power line plug 10 and is adjacent to the connection portion 111, and the pull lug 12 and the power line 13 are in different directions.

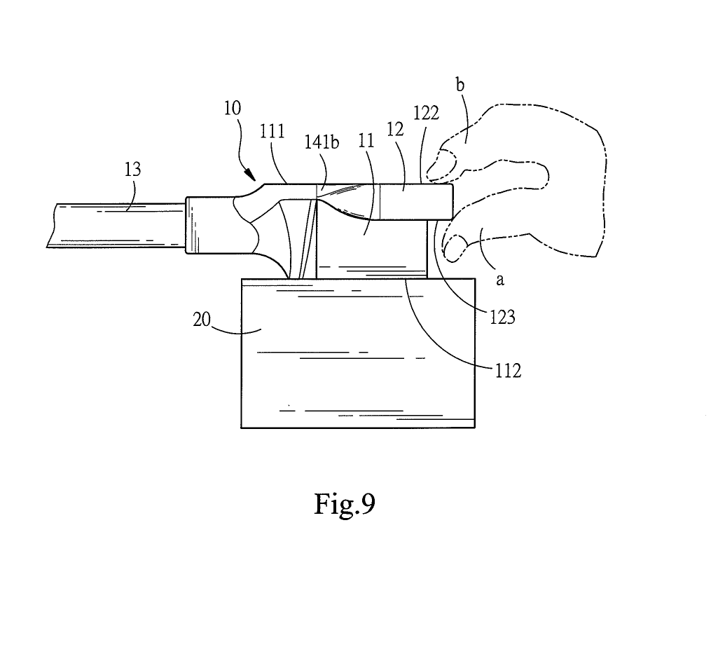

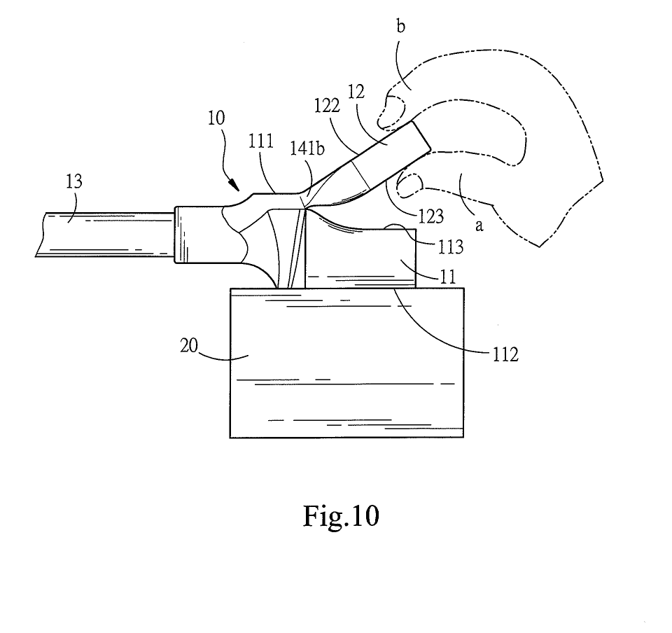

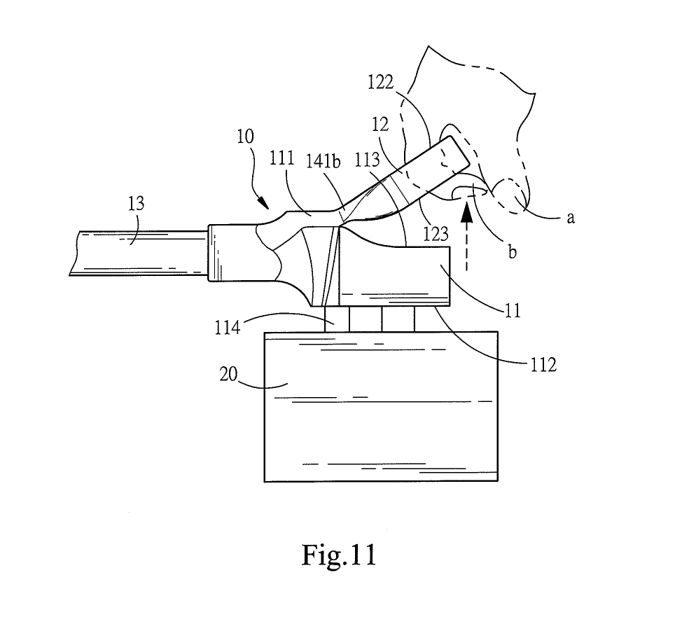

Therefore, during use, referring to FIG. 9 to FIG. 11 together, FIG. 9, FIG. 10, and FIG. 11 are first, second and third schematic views of an action on a socket 20 in cooperation according to an embodiment of the present invention. The power line plug 10 is inserted into a plug hole 21 of the socket 20 by means of a plug pin 114 below an abutting surface 112, so as to connect to a power supply which supplies power to a power line 13, and the other end of the power line 13 is connected to an electrical product (not shown). If it is intended to unplug the power line plug 10 from the socket 20, a thumb a of a user may push the pull lug 12 upward, so that an oblique angle is formed between the pull lug 12 and the fixing base 11, which facilitates an index finger b to be hooked into the pull lug 12; then a force is applied to lift the pull lug 12 upward, so that the plug pin 114 of the power line plug 10 is separated from the plug hole 21 of the socket 20, and advantages of simple and convenient operation, rapidness and being easy to use are provided.

It should be noted that, in the present invention, the pull lug 12 extends out from the connection portion 111, it is equivalent to that the pull lug 12 and the power line plug 10 are integrally formed, and the manufacturing and the structure are simple, so that the manufacturing cost is low, and the selling price is low and is in favor with a majority of consumers so as to have a market competitiveness. Importantly, the pull lug 12 and the power line plug 10 are integrally bound to be characterized by firmness and durability, so that the pull lug 12 is not separated from the power line plug 10 because the user excessively applies a force.

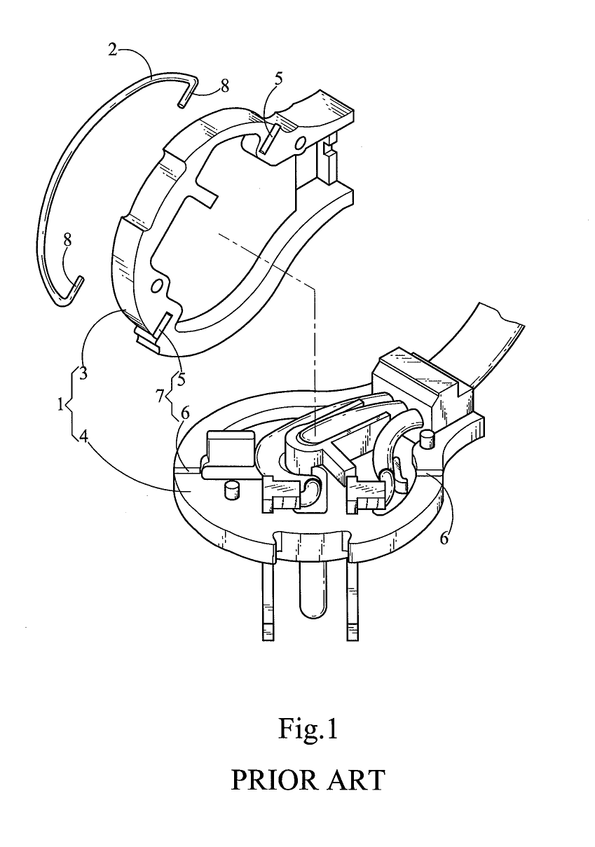

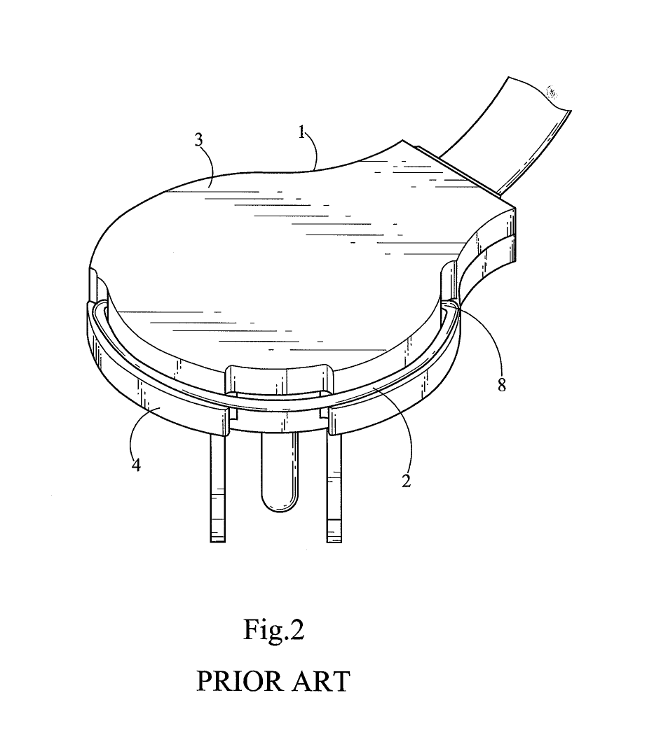

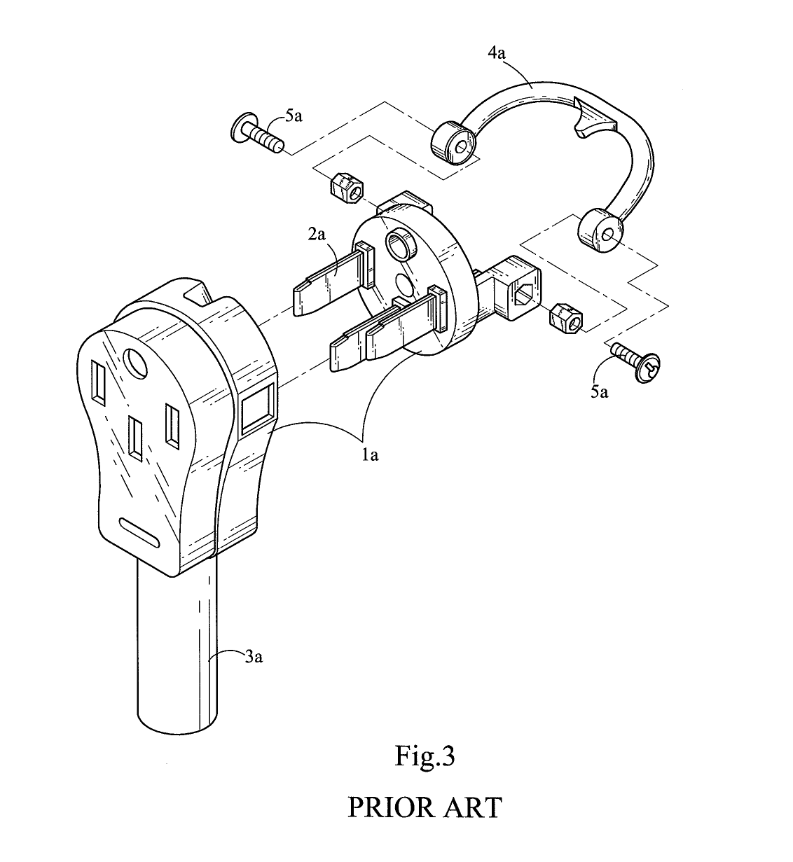

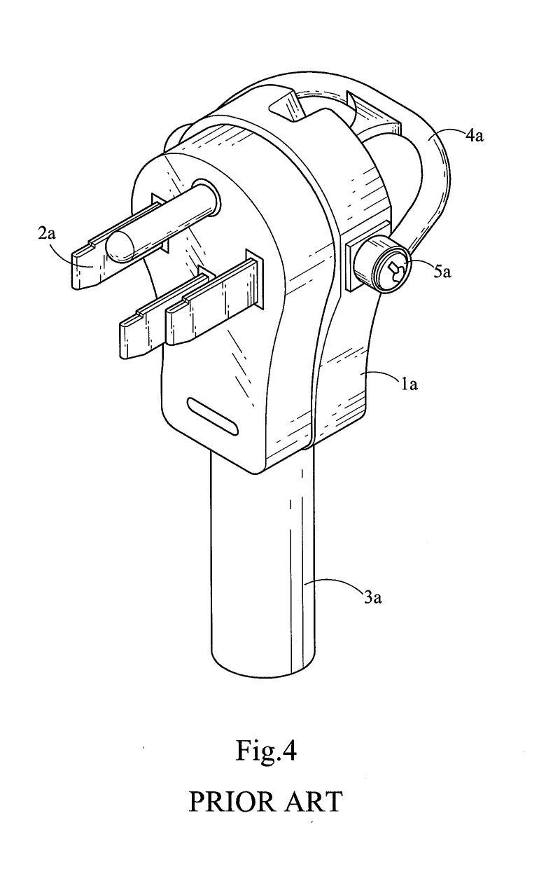

To sum up, the present invention sufficiently solves the problem of the first flat plug in the prior art shown in FIG. 1 and FIG. 2 that, when a drawing force of a user for drawing a pull ring is greater than a binding force of the pull ring and the plug, the pull ring is deformed to make a hooking lug get out of an inner hole, so as to cause a danger of tumbling or tossing a palm out to collide with a hard object. Compared with the second flat plug in the prior art shown in FIG. 3 and FIG. 4, the plug of the present invention has advantages of a simpler structure, a greatly reduced manufacturing cost, and a relatively lower selling price, being acceptable to a majority of consumers and having a market competitiveness.

The present invention is disclosed above with preferable embodiments, but a person skilled in the art should understand that, the embodiments are only intended to describe the present invention, but should not be construed as a limitation to the scope of the present invention. It should be noted that, all changes and replacements equivalent to the embodiments should fall within the scope of the present invention. Therefore, the protection scope of the present invention should be defined by the following claims.

What is claimed is:

1. A power line plug, plugged into a socket to connect to a power supply, wherein the power line plug comprises:
a fixing base, having a connection portion, an abutting surface abutting the socket and an outer side with the back facing the abutting surface, wherein the abutting surface is provided with a plurality of plug pins, and one of the plug pins is inserted into a plug hole of the socket; and
a pull lug, surrounding the periphery of the fixing base, wherein an interval exists between the pull lug and the fixing base, the pull lug has a first end and a second end, the thickness of each of which is less than that of the pull lug and which are connected to the connection portion, and the first end and the second end have elastic deflection, so that the pull lug performs direction rotation by means of the first end and the second end.

2. The power line plug according to claim 1, wherein the power line plug is connected to a power line, one end of the power line is connected to a periphery portion of the power line plug and is adjacent to the connection portion, and the pull lug and the power line are in different directions.

3. The power line plug according to claim 2, wherein the fixing base is semi-circular, the interval is disposed around the outline of the fixing base and passes through the diameter of the fixing base, two ends of the interval then extend toward the direction of the power line and terminate at the connection portion, and the distance between the two ends of the interval is less than the diameter of the fixing base, so that the fixing base is formed with a mushroom head outline.

4. The power line plug according to claim 1, wherein the pull lug is adjacent to the outer side, and the thickness of the pull lug is less than the thickness of the fixing base.

5. The power line plug according to claim 4, wherein a diametric plane of the pull lug away from the plug pin and the outer side are different planes, and another diametric plane of the pull lug adjacent to the plug pin is lower than the abutting surface.

6. The power line plug according to claim 4, wherein the first end and the second end of the pull lug are twisted so that the first end and the second end decrease in the thickness and are connected to the connection portion.
